(19) United States
(12) Patent Application Publication
(10) Pub. No.: US 2017/0182431 A1
(43) Pub. Date: Jun. 29, 2017

(54) PROCESS AND SYSTEM FOR RECOVERING WATER FROM AN EMULSION PRODUCED FROM A HYDROCARBON PRODUCTION OPERATION

(71) Applicant: Cenovus Energy Inc., Calgary (CA)

(72) Inventors: Subodh GUPTA, Calgary (CA); Michael N. HOLMES, Calgary (CA); Michael Patrick MCKAY, Calgary (CA); Suchang REN, Calgary (CA); Susan Wei SUN, Calgary (CA)

(21) Appl. No.: 15/392,971

(22) Filed: Dec. 28, 2016

Related U.S. Application Data
(60) Provisional application No. 62/272,396, filed on Dec. 29, 2015.

(51) Int. Cl. B01D 3/14; B01D 3/06; E21B 43/34; B01D 19/00; C02F 1/06; C02F 1/16; B01D 3/00; B01D 17/04

(52) U.S. Cl. CPC B01D 3/143; B01D 3/007; B01D 3/06; B01D 17/047; B01D 19/00; C02F 1/06; C02F 1/16; E21B 43/34; E21B 43/2406

(57) ABSTRACT

A process for recovering water from an emulsion produced from a hydrocarbon production operation. The process includes heating the emulsion to generate water vapor, separating the water vapor from oil in the emulsion, compressing the water vapor separated from the oil, thereby increasing pressure to provide condensate, wherein heat generated from compression of the water vapor to provide condensate is utilized to provide heat for heating the emulsion, and separating at least one of remaining oil, gas, or water from the condensate.

### TECHNICAL FIELD

The present invention relates to the recovery of water produced from a hydrocarbon production operation for producing steam that is utilized in the hydrocarbon production operation.

### BACKGROUND

Extensive deposits of viscous hydrocarbons exist around the world, including large deposits in the northern Alberta oil sands that are not susceptible to standard oil well production technologies. Such deposits may be referred to as reservoirs of heavy hydrocarbons, heavy oil, bitumen, bituminous sands, or oil sands. The hydrocarbons in such deposits are too viscous to flow at commercially relevant rates at the temperatures and pressures present in the reservoir. For such reservoirs, thermal techniques may be utilized to heat the reservoir to mobilize the hydrocarbons and produce the heated, mobilized hydrocarbons from wells. One such technique for recovering viscous hydrocarbons using alternating injection of steam and production of fluid from a well in a hydrocarbon reservoir is known as cyclic steam stimulation (CSS). One such technique for utilizing a horizontal well for injecting heated fluids and producing hydrocarbons is described in U.S. Pat. No. 4,116,275, which also describes some of the problems associated with the production of mobilized viscous hydrocarbons from horizontal wells.

One thermal method of recovering viscous hydrocarbons using spaced horizontal wells is known as steam-assisted gravity drainage (SAGD). SAGD utilizes gravity in a process that relies on the density difference of the mobile fluids to achieve a desirable vertical segregation within the reservoir. Various embodiments of the SAGD process are described in Canadian Patent No. 1,304,287 and corresponding U.S. Pat. No. 4,344,485. In the SAGD process, pressurized steam is delivered through an upper, horizontal, injection well, into a viscous hydrocarbon reservoir while hydrocarbons are produced from a lower, parallel, horizontal production well that is near the injection well and is vertically spaced from the injection well. The injection and production wells are typically situated in the lower portion of the reservoir, with the producer located close to the base of the hydrocarbon deposit to collect the hydrocarbons that flow toward the base of the deposit.

The SAGD process is believed to work as follows. The injected steam initially mobilizes the hydrocarbons to create a steam chamber in the reservoir around and above the horizontal injection well. The term steam chamber is utilized to refer to the volume of the reservoir that is saturated with injected steam and from which mobilized oil has at least partially drained. As the steam chamber expands, viscous hydrocarbons in the reservoir and water originally present in the reservoir are heated and mobilized and move with aqueous condensate from the steam, under the effect of gravity, toward the bottom of the steam chamber. The hydrocarbons, the water originally present, and the aqueous condensate are typically referred to collectively as produced emulsion. The produced emulsion accumulates such that the liquid/vapor interface is located below the steam injector and above the producer. The produced emulsion is collected and produced from the production well. The produced emulsion is separated into dry oil for sales and produced water, comprising the water originally present and the aqueous condensate.

The water that is collected, including the steam that is injected into the reservoir through the injection well, is recycled as the emulsion produced from the production well is treated to separate the water, which is reused to generate steam. The separation of water may include several processes, including, for example, the use of diluents and demulsifying chemicals and separation in a gravity separator to treat the water. The water may also be separated utilizing, for example, skim tanks, induced gas flotation, filtration, warm lime softening, and ion exchange. Such processes are capital intensive and generally provide water with high dissolved solids, necessitating the use of specialized equipment such as once-through steam generators (OSTGs) for steam generation.

Improvements in the recovery of water for use in hydrocarbon production processes are desirable.

### SUMMARY

According to an aspect of an embodiment, a process for recovering water from an emulsion produced from a hydrocarbon production operation is provided. The process includes heating the emulsion to generate water vapor, separating the water vapor from oil in the emulsion, compressing the water vapor separated from the oil, thereby increasing pressure to provide condensate, wherein heat generated from compression of the water vapor to provide condensate is utilized to provide heat for heating the emulsion, and separating at least one of remaining oil, gas, or water from the condensate.

According to another aspect, a system for recovering water from an emulsion produced from a hydrocarbon production operation is provided. The system includes a heat exchanger for heating the emulsion to provide a heated emulsion, a flash vessel in fluid communication with the heat exchanger for receiving the heated emulsion and vaporizing water from the heated emulsion to separate water vapor from oil, a compressor in fluid communication with the flash vessel and the heat exchanger for receiving the water vapor separated from the oil and compressing the water vapor thereby increasing pressure to provide condensate, wherein heat generated from compression of the water vapor to provide condensate is utilized to provide heat in the heat exchanger for heating the emulsion, and a first separator for separating at least one of remaining oil, gas, or water from the condensate.

### BRIEF DESCRIPTION OF THE DRAWINGS

Embodiments of the present invention will be described, by way of example, with reference to the drawings and to the following description, in which:

FIG. 1 is a sectional view through a reservoir, illustrating a SAGD well pair;

FIG. 2 is a sectional side view illustrating a SAGD well pair including an injection well and a production well;

FIG. 3 is a process flow diagram illustrating a process for recovery of water from an emulsion produced in a hydrocarbon production operation, in accordance with one embodiment of the present invention;

FIG. 4 is a process flow diagram illustrating a process for recovery of water from an emulsion produced in a hydrocarbon production operation, in accordance with another embodiment of the present invention;

FIG. 5 is a process flow diagram illustrating a process for recovery of water from an emulsion produced in a hydrocarbon production operation, in accordance with yet another embodiment of the present invention;

FIG. 6 is a process flow diagram illustrating a simulation model for recovery of water from an emulsion produced in a hydrocarbon production operation, in accordance with an embodiment of the present invention.

### DETAILED DESCRIPTION

For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein.

The disclosure generally relates to a system and a process for recovering water from an emulsion produced from a hydrocarbon production operation. The process includes heating the emulsion to generate water vapor, separating the water vapor from oil, such as bitumen, in the emulsion, compressing the water vapor separated from the oil, thereby increasing pressure to provide condensate, wherein heat generated from compression of the water vapor to provide condensate is utilized to provide heat for heating the emulsion, and separating at least one of remaining oil, gas, or water from the condensate.

Reference is made herein to an injection well and a production well. The injection well and the production well may be physically separate wells. Alternatively, the production well and the injection well may be housed, at least partially, in a single physical wellbore, for example, a multilateral well. The production well and the injection well may be functionally independent components that are hydraulically isolated from each other, and housed within a single physical wellbore.

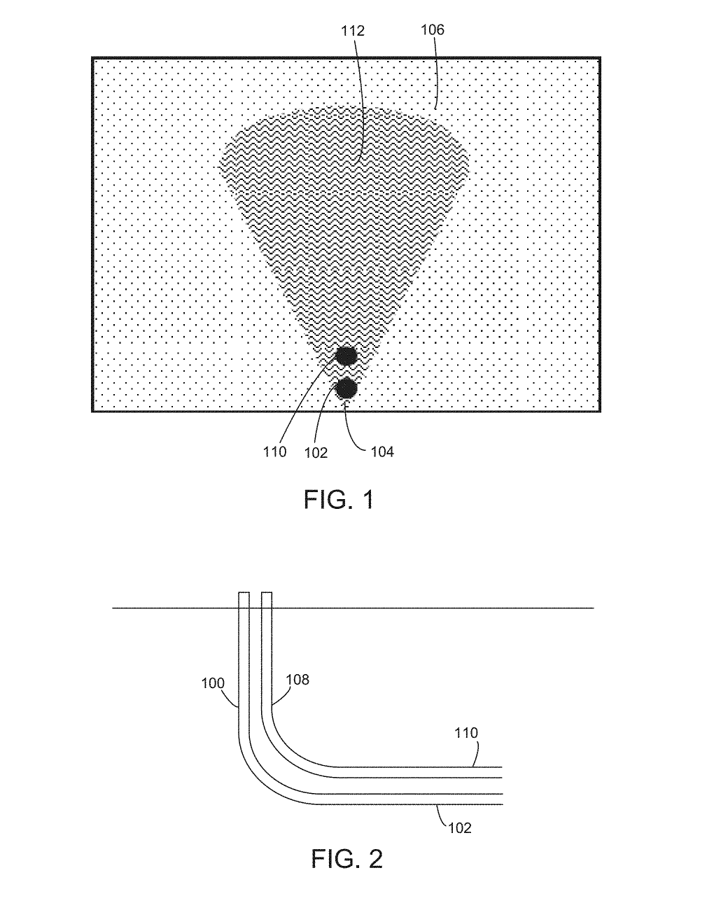

As described above, a steam-assisted gravity drainage (SAGD) process may be utilized for mobilizing viscous hydrocarbons. In the SAGD process, a well pair, including a hydrocarbon production well and a steam injection well are utilized. One example of a well pair is illustrated in FIG. 1 and an example of a hydrocarbon production well 100 and injection well 108 is illustrated in FIG. 2. The hydrocarbon production well 100 includes a generally horizontal segment 102 that extends near the base or bottom 104 of the hydrocarbon reservoir 106. The injection well 108 also includes a generally horizontal segment 110 that is disposed generally parallel to and is spaced generally vertically above the horizontal segment 102 of the hydrocarbon production well 100.

During SAGD, steam is injected into the injection well 108 to mobilize the hydrocarbons and create a steam chamber 112 in the reservoir 106, around and above the generally horizontal segment 110. In addition to steam injection into the injection well, light hydrocarbons, such as C₃ through C₁₀ alkanes, either individually or in combination, may optionally be injected with the steam such that the light hydrocarbons function as solvents in aiding the mobilization of the hydrocarbons. The volume of light hydrocarbons that are injected is relatively small compared to the volume of steam injected. The addition of light hydrocarbons is referred to as a solvent aided process (SAP). Alternatively, or in addition to the light hydrocarbons, various non-condensing gases, such as methane or carbon dioxide, may be injected. Viscous hydrocarbons in the reservoir are heated and mobilized and the mobilized hydrocarbons drain under the effect of gravity. The produced emulsion, which includes the mobilized hydrocarbons along with produced water, is collected in the generally horizontal segment 102. The emulsion also includes gases such as steam and production gases from the SAGD process.

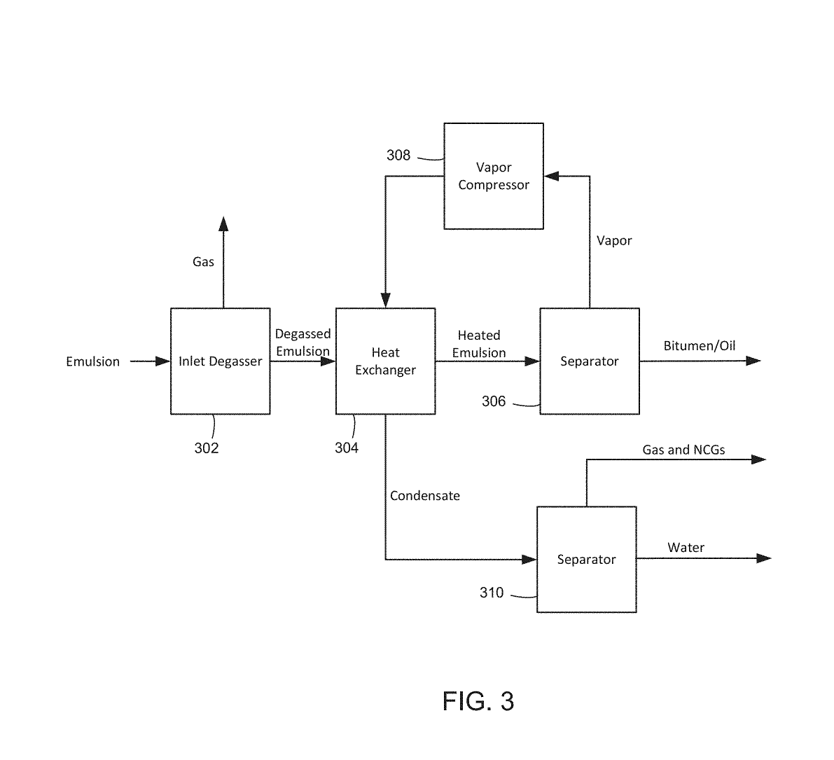

The steam that is utilized to mobilize the hydrocarbons may be generated at least partially from the water recovered from the produced emulsion. The emulsion, however, includes oil and gases, as well as contaminants such as silica, calcium, magnesium, and iron. As used herein, a reference to water being recovered from an emulsion includes but is not limited to pure water, and includes water that is contaminated by contaminants, such as hydrocarbons. A process flow diagram illustrating a process for recovery of water from an emulsion produced in a hydrocarbon production operation is illustrated in FIG. 3. The produced emulsion includes oil, water, gas, and solids. The water to oil ratio in the produced emulsion may be, for example, about 70:30.

As illustrated in FIG. 3, the produced emulsion from a production well, such as the production well 100, is subjected to degassing. In the present example, the emulsion is received in an inlet degasser 302, from a well of a hydrocarbon production operation such as the hydrocarbon production well 100, without any intervening separation of the water from the oil. The inlet degasser 302 is a two-phase separator utilized for separating some of the gas from the liquid in the emulsion. Thus, at least some of the gas is removed from the emulsion prior to introduction of the emulsion into a heat exchanger, resulting in a degassing product and a degassed emulsion.

The degassed emulsion from the inlet degasser 302 is heated in a heat exchanger 304. Thus, the emulsion introduced into the heat exchanger is received from the production well without having been subjected to any separation of water from oil. In the heat exchanger, the degassed emulsion is heated to a temperature that is above the flashing point of water at the pressure in a separator 306, such as a flash vessel. The heat exchanger may include a falling film evaporator. The heated emulsion is received in the separator 306 that is in fluid communication with the heat exchanger 304. The majority of the water in the heated emulsion is vaporized in the separator 306 while the majority of the oil in the emulsion remains in liquid state. The oil, along with solids from the emulsion, is separated from the vapor in the separator 306. The oil and solids separated in the separator 306 may be subjected to separation or to the addition of a diluent and the resulting oil may be forwarded or shipped for sale. Some emulsion may remain after water vaporization in the separator 306. Optionally, a recycle loop involving the heat exchanger 304 and the separator 306 may be utilized to circulate emulsion between the heat exchanger and the separator for improved separation.

The water vaporized in the separator 306, which also includes light hydrocarbons in the form of gases, is compressed in a vapor compressor 308 that is in fluid communication with the separator 306 to increase the pressure. The compressor 308 may be any suitable compressor. The temperature of the water also increases as the water condenses, and the latent heat is released during condensation. The hot condensate is passed through the heat exchanger 304 to exchange heat with the degassed emulsion, thereby heating the degassed emulsion utilizing the latent heat from condensation of the water vaporized in the separator 306. The condensate is maintained separate from the emulsion in the heat exchanger 304 such that the condensate does not mix with the emulsion, while facilitating heat exchange between the condensate and the emulsion.

After passing through the heat exchanger 304, the condensate is received in a separator to separate out the water. The separator may be a three-phase separator to separate remaining hydrocarbon condensate and gas. The remaining hydrocarbon condensate may be reused or blended with the oil from the separator 306. The gas, which includes non-condensable gases, may be subsequently processed with the gas from the inlet degasser 302.

The resulting water from the separator 310 may be utilized in the hydrocarbon production operation. For example, the resulting water may be subjected to heating in a boiler to generate steam that is utilized to mobilize the hydrocarbons in the hydrocarbon reservoir.

To start the process described above and illustrated in FIG. 3, an external source of heat is provided to heat the degassed emulsion to a temperature that is above the flashing point of water at the operating pressure in the separator. The external source of heat may be, for example, from an external source of steam or from a secondary heating source. Optionally, a recycle loop involving the heat exchanger and the vapor compressor may be utilized to achieve a temperature above the flashing point of water at the pressure in the separator at the start of the process. After starting the process and during operation of the system, however, condensation of the vapor resulting from compression in the vapor compressor 308 provides the heat utilized to heat the degassed emulsion and the process may continue without further heating from any external source.

In another embodiment, more than one heat exchanger may be utilized. For example, heat exchange duty may be portioned between two or more smaller heat exchangers, rather than one or more larger heat exchangers.

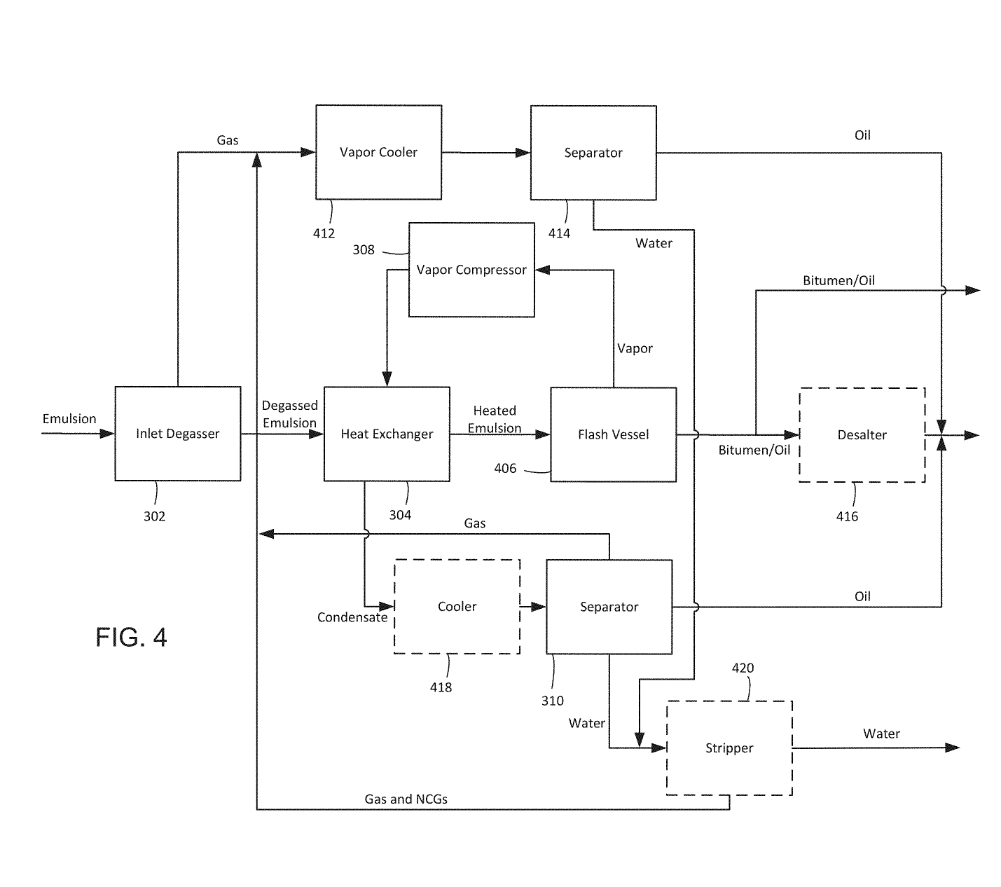

A process flow diagram illustrating a process for recovery of water from an emulsion produced in a hydrocarbon production operation according to another embodiment is illustrated in FIG. 4. Many of the processes of FIG. 4 are similar to processes described above with reference to FIG. 3 and thus, these processes are not described again in detail. As described above, the produced emulsion from the hydrocarbon production operation includes oil, water, gas, and solids.

As illustrated in FIG. 4, the produced emulsion is received in an inlet degasser 302 and is subjected to degassing. The produced emulsion is received from a well of a hydrocarbon production operation such as the hydrocarbon production well 100, without intervening separation of the water from the oil. As described with reference to FIG. 3, at least some of the gas is removed from the emulsion prior to introduction of the emulsion into the heat exchanger 304.

As illustrated in FIG. 4, the degassing product, which includes the gas removed from the emulsion and that is separated from the emulsion in the inlet degasser 302, is subjected to cooling in a vapor cooler 412, followed by separation in a separator 414 to separate and remove the oil and the water from the degassing product. The water is added to the water from the three-phase separator 310.

The degassed emulsion from the inlet degasser 302 is heated in the heat exchanger 304 and received in the separator, which in this embodiment is a flash vessel 406. The oil, as well as solids from the emulsion, is separated from the vapor in the flash vessel 406. The oil and solids separated in the flash vessel 406 are optionally subjected to separation in a desalter 416 to separate the oil from the solids and the oil is forwarded or shipped for sale or further processing. The oil separated from the degassing product in the separator 414 is added to the resulting oil from the desalter 416. Thus, the emulsion is subjected to heating in the heat exchanger 304 and separating in the flash vessel 406 without prior separation of water from oil in the emulsion.

The water vaporized in the flash vessel 406 is subjected to compression in the vapor compressor 308 and is passed through the heat exchanger 304 to exchange heat with the degassed emulsion, thereby heating the degassed emulsion utilizing the latent heat from condensation of the water subjected to compression in the vapor compressor 308.

After passing through the heat exchanger 304, the condensate is optionally subjected to cooling in a cooler 418, followed by separation in the separator 310 to separate remaining oil and gas from the condensate. The remaining oil that is separated in the separator 310 may be reused or blended with the oil exiting the desalter 416.

The condensate is then optionally subjected to stripping in a stripper 420 to strip out the gases, which include non-condensable gases that are subsequently subjected to vapor cooling in the vapor cooler 412 with the gas from the inlet degasser 302.

The resulting water from the stripper 420 is utilized in the hydrocarbon production operation. For example, the resulting water may be subjected to heating in a boiler to generate steam that is utilized to mobilize the hydrocarbons in the hydrocarbon reservoir.

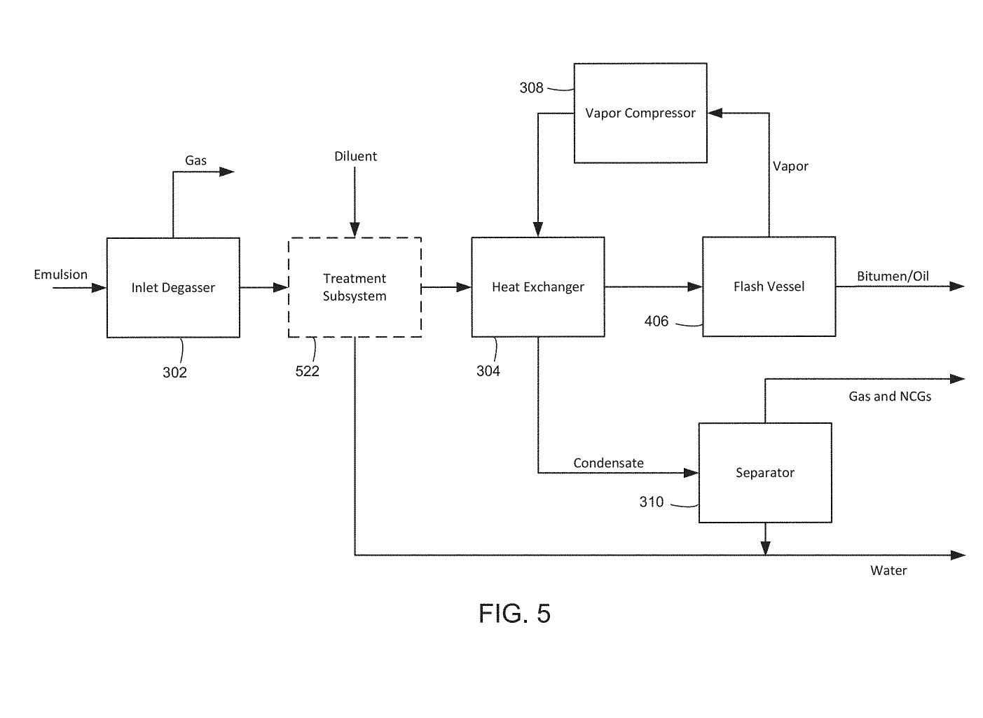

Reference is now made to FIG. 5, which illustrates a process for recovery of water from an emulsion produced in a hydrocarbon production operation according to yet another embodiment. Many of the processes of FIG. 5 are similar to processes described above with reference to FIG. 3 and thus, these processes are not described again in detail. As described above, the produced emulsion from the hydrocarbon production operation includes oil, water, gas, and solids.

The produced emulsion, received from a well of a hydrocarbon production operation, is received in the inlet degasser 302 and is subjected to degassing to remove at least some of the gas.

In this example, however, the degassed emulsion from the inlet degasser is subjected to pre-treatment in a treatment subsystem 522, prior to heat exchange in the heat exchanger 304. The pre-treatment includes adding a diluent to the emulsion prior to heat exchange in the heat exchanger 304 and prior to separating in the flash vessel 406. The pre-treatment may also include removing at least a portion of water or solids or both water and solids from the remaining emulsion prior to introduction into the heat exchanger 304.

The remaining emulsion, after pre-treatment, is heated in the heat exchanger 304 and received in a flash vessel 406 to separate the oil and solids from the vapor. As described with reference to FIG. 3, the water vaporized in the flash vessel 406 is subjected to compression in the vapor compressor 308 and is passed through the heat exchanger 304 to exchange heat with the degassed and pre-treated emulsion, thereby heating the degassed and pre-treated emulsion utilizing the latent heat from condensation of the water subjected to compression in the vapor compressor 308.

After passing through the heat exchanger 304, the condensate is received in a separator to separate out the water. The resulting water from the separator 310 may be utilized in the hydrocarbon production operation, along with any water produced from the pre-treatment in the treatment subsystem 522. For example, the resulting water may be subjected to heating in a boiler to generate steam that is utilized to mobilize the hydrocarbons in the hydrocarbon reservoir.

Although the emulsion is pre-treated in a treatment subsystem, the volume of diluent and the chemicals utilized in the pre-treatment are significantly less than the volume of diluent and chemicals utilized in prior art water recovery processes.

In each of the embodiments described above, the heat that is utilized in the separation of the water from the oil by separating water vapor from remaining oil and solids is provided by the condensation of the same water vapor in a cyclical process in which emulsion is heated by the water vapor that is produced and condenses. Such a process advantageously reduces or eliminates the use of diluent and chemical additions for emulsion separation. Demulsifying chemicals utilized to reduce interfacial tension between oil and water for coalescence to enhance, for example, gravity separation, are also reduced or are unnecessary.

In addition, fewer processes and equipment may be utilized, and the resulting water may have fewer contaminants including dissolved solids. Thus, boilers may be utilized to generate steam from the resulting water rather than utilizing specialized equipment such as once-through steam generators.

### EXAMPLE

The following example is submitted to further illustrate an embodiment of the present invention. This example is intended to be illustrative only and is not intended to limit the scope of the present invention.

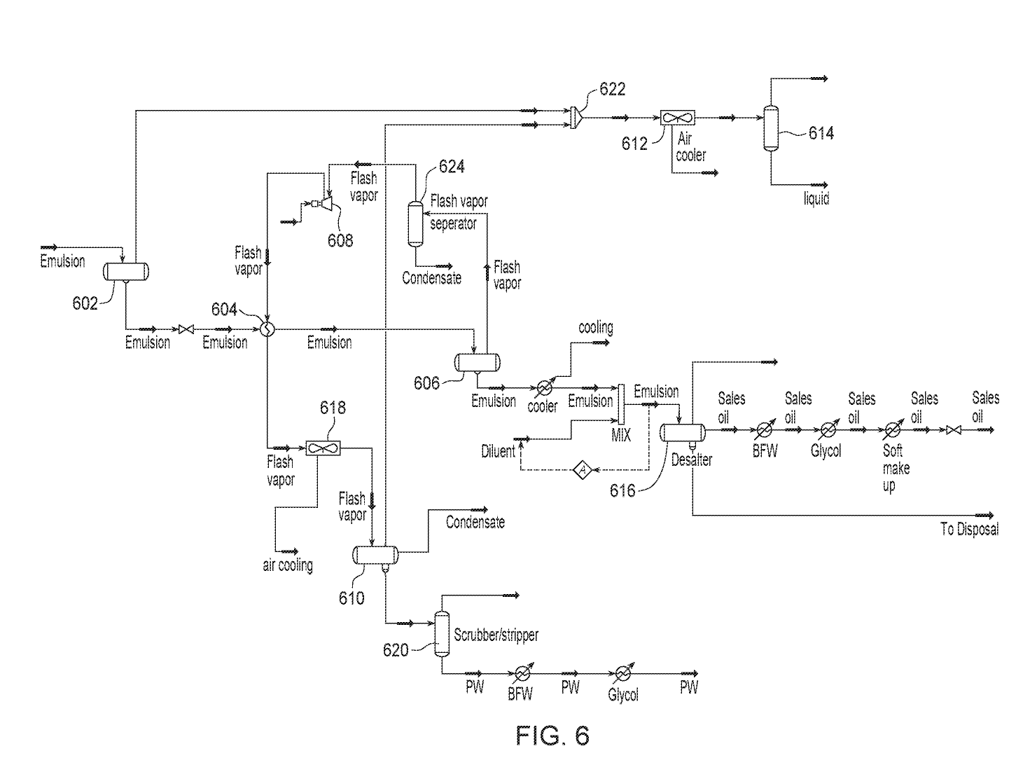

A simulation model using Honeywell's UniSim® Design R430 software was developed to test the performance of the process and system shown in FIG. 4. The simulation model is illustrated in FIG. 6 and included various input parameters and other considerations referred to below. For the simulation model shown in FIG. 6, the reference numerals used to denote the elements are similar to those of FIG. 4, with the exception that the reference numerals are raised by 200 or 300 such that all elements in FIG. 6 are denoted by reference numerals in the 600s for the specific simulation model elements.

The simulation model represents a 50,000 bbl/d facility (producing 50,000 barrels of produced emulsion per day). As shown in FIG. 6, produced emulsion was first provided to an inlet degasser 602 in the simulation model to remove as much produced gas as possible before the emulsion enters the heat exchanger 604. After degassing, the degassing product entered a produced gas cooler 612, followed by a knock-out drum 614 for separating the liquid and vapor components of the degassing product.

The degassed emulsion from the inlet degasser 602 entered the heat exchanger 604, which was modelled on heat exchanger equipment from Heat Transfer Research Inc. (HTRI), a company headquartered in Texas, USA. The model heat exchanger was a horizontal Tubular Exchanger Manufacturers Association (TEMA) AFU type shell and tube heat exchanger. The heat exchanger 604 included double segmental perpendicular baffles with 17 cross passes, two shells in series arrangement, and it was assumed that there was no fouling factor.

To assess heat exchanger feasibility and achieve the desired product streams from the simulation model, the total heat duty was estimated at 303 MW for a degassed emulsion flowrate of 267.7 kg/s. With an effective heat exchanger area of 23,117 m² and a simulation output of 120% overdesign, reflecting the heat exchanger surface area required to ensure optimal heat exchanger performance efficiency, the heat transfer coefficient was estimated at 2,335 W/m²K, which is equivalent to 20 parallel heat exchangers, each with two shells in series, in the simulation model.

The simulation model indicated that the degassed emulsion enters the heat exchanger at a 3% vapor fraction and is heated to vaporize water to a 98% vapor fraction. The emulsion temperature increased very little, as most of the heat was adsorbed by vaporization.

The condensed stream from the heat exchanger 604 may include a small remaining vapor fraction due to the limited Mechanical Vapor Recompression (MVR) ratio of ˜1.5; therefore, a chiller 618 in the simulation model provided the option of condensing the extra steam vapor to generate produced water. Otherwise, the vapor was provided to the produced gas mix drum 622.

From the heat exchanger, the remaining multiphase stream was separated in a flash vessel 606 at an operational pressure of 1095 kPa. The size of the flash vessel 606 was estimated based on Svrcek, W. Y. & Monnery, W. D. Chemical Engineering Progress, October 1993, pp. 53-60, incorporated herein by reference, in which a two-phase separator was utilized to calculate the required flash vessel length. The calculation was based on the following input parameters:
Vapor and liquid flowrates and other conditions obtained from the results of the simulation model;
Assumed minimum liquid droplet size of 300 μm in gas for phase separation;
Droplets assumed to be spherical in shape;
Maximum vessel diameter of 4.26 m (14 ft) to meet vessel transportation limits;
Vessel holdup time: 3 min; and
Vessel surge time: 5 min.

As the result of flash vessel analysis, vertical terminal velocity was calculated as 2.1 ft/s. Despite the volume of holdup and surge, the phase interface was set at 50% of flash vessel height, which left half the internal flash vessel volume available for separation. The percent height fluctuates during the simulation/operation as fluids flow through the process. The vessel length for separation was calculated to be 15.6 m (51 ft). Calculated results are summarized in the following table.

TABLE 1
Flash Vessel Sizing Calculation

| | Calculated | |
|---|---|---|
| Variables | Results | Units |
| Vapor mass flowrate | 653,200 | kg/h |
| Liquid mass flowrate | 310,400 | kg/h |
| Drag coefficient C for sphere | 0.9 | Dimensionless |
| droplets | | |
| Terminal velocity | 2.1 | ft/s |
| Liquid level | 7 | ft |
| Vessel diameter | 14 | ft |
| Vessel length | 51 | ft |
| Length/Diameter ratio | 3.6 | Dimensionless |

From the flash vessel 606, the vapor was collected and compressed in a heavy duty vapor compressor 608 (˜15-20 MW power) in the simulation model. The vapor compressor 608 was operated within the simulation model at 75% adiabatic efficiency. A compressor skid involving more than one compressor unit, e.g., 2×10 MW power compressor units, may be used. Depending on the type of compressor, a separator, e.g., a knock-out scrubber, 624 may be required to remove a liquid component in the vapor from the flash vessel 606 before vapor compression in the vapor compressor 608.

After the condensate passed from the vapor compressor 608 through the shell side of the heat exchanger 604, the condensate was provided to the chiller 618 in the simulation model to increase the condensation of vapor to liquid in the downstream three-phase separator 610. In simulations where the chiller 618 was not used, the degassing product entered a produced gas mix drum 622 prior to entering the produced gas cooler 612. The condensate was then provided to a stripper 620 to strip out the gases, which are subsequently subjected to vapor cooling in the cooler 612.

On the sales oil side, it was assumed for the simulation model that solids in the stream from the flash vessel would be removed from the oil in a desalter 616 without addition of diluent.

Electricity was utilized to power the vapor compressor 608. To evaluate energy efficiency, an upper range of the 20 MW vapor compressor was modeled to treat inlet emulsion at a rate of 1,100 m³/h and resulted in an energy factor of 18.2 kWh/m³ of emulsion treated, meaning that only ˜5% of the energy utilized to vaporize the water was provided by the vapor compressor 608.

The described embodiments are to be considered in all respects only as illustrative and not restrictive. The scope of the claims should not be limited by the preferred embodiments set forth in the examples, but should be given the broadest interpretation consistent with the description as a whole. All changes that come with meaning and range of equivalency of the claims are to be embraced within their scope.

1. A process for recovering water from an emulsion produced from a hydrocarbon production operation, the process comprising:
heating the emulsion to generate water vapor;
separating the water vapor from oil in the emulsion;
compressing the water vapor separated from the oil, thereby increasing pressure to provide condensate, wherein heat generated from compression of the water vapor to provide condensate is utilized to provide heat for heating the emulsion;
separating at least one of remaining oil, gas, or water from the condensate.

2. The process according to claim 1, comprising generating steam from the water for use in the hydrocarbon production operation.

3. The process according to claim 1, wherein the emulsion comprises oil, water, gas, and solids.

4. The process according to claim 3 wherein the emulsion is received from a well of a hydrocarbon production operation without intervening separation of the water from the oil.

5. The process according to claim 3, comprising degassing, prior to separating the water vapor from the oil, to provide a degassing product and thereby remove at least some of the gas from the emulsion.

6. The process according to claim 5, comprising cooling the degassing product to remove remaining oil and water from the degassing product.

7. The process according to claim 3, comprising treating the emulsion to remove at least a portion of the water, the solids, or a combination of the water and the solids from the emulsion prior to separating the water vapor from the oil.

8. The process according to claim 3, comprising removing at least a portion of the solids from the oil.

9. The process according to claim 1, comprising cooling the condensate prior to separating the at least one of the remaining oil, gas, or water from the condensate.

10. The process according to claim 1, comprising adding a diluent to the emulsion prior to separating the water vapor from the oil.

11. The process according to claim 1, wherein a majority of the oil remains liquid during the heating and the separating the water vapor from the oil.

12. The process according to claim 1, wherein a majority of the water vaporizes during the heating and the separating the water vapor from the oil.

13. A system for recovering water from an emulsion produced from a hydrocarbon production operation, the system comprising:
a heat exchanger for heating the emulsion to provide a heated emulsion;
a flash vessel in fluid communication with the heat exchanger for receiving the heated emulsion and vaporizing water from the heated emulsion to separate water vapor from oil;
a compressor in fluid communication with the flash vessel and the heat exchanger for receiving the water vapor separated from the oil and compressing the water vapor thereby increasing pressure to provide condensate, wherein heat generated from compression of the water vapor to provide condensate is utilized to provide heat in the heat exchanger for heating the emulsion;
a first separator for separating at least one of remaining oil, gas, or water from the condensate.

14. The system according to claim 13 comprising a steam generator for receiving the water from the first separator and generating steam for use in the hydrocarbon production operation.

15. The system according to claim 13, comprising a degasser for removing gas from the emulsion prior to delivering the emulsion to the heat exchanger.

16. The system according to claim 15, comprising a first cooler for cooling the gas removed from the emulsion.

17. The system according to claim 13, comprising a treatment subsystem for removing at least a portion of water, solids, or a combination of water and solids from the emulsion prior to receipt of the emulsion in the heat exchanger.

18. The system according to claim 13, comprising a desalter for removing solids from the oil from the flash vessel.

19. The system according to claim 13, comprising a second cooler for cooling the condensate prior to receipt of the condensate in the first separator.

20. The system according to claim 13, comprising a stripper for receiving the water from the first separator and stripping remaining gas from the water received from the first separator.
